(19) United States
(12) Patent Application Publication
(10) Pub. No.: US 2014/0196360 A1
(43) Pub. Date: Jul. 17, 2014

(54) APPLICATIONS OF GLASS MICROPARTICLES AND NANOPARTICLES MANUFACTURED FROM RECYCLED GLASSES

(71) Applicant: Kamal Sarkar, Edinburg, TX (US)

(72) Inventor: Kamal Sarkar, Edinburg, TX (US)

(21) Appl. No.: 14/156,080

(22) Filed: Jan. 15, 2014

Related U.S. Application Data
(60) Provisional application No. 61/752,708, filed on Jan. 15, 2013.

(51) Int. Cl. C03C 3/04; C10L 1/12; B01D 15/00

(52) U.S. Cl. CPC C03C 3/04; B01D 15/00; C10L 1/1291
USPC 44/457; 588/249

(57) ABSTRACT

Glass microparticles and/or glass nanoparticles have been developed for use as: reflective paints; abrasive papers/wheels; flame retardant paints; thermal insulation for aggregates, self-cleaning building materials, absorbent of oils, diesel, gasoline, brake fluids, transmission fluids, ethanol, methanol, and acetone; cosmetics (lipstick, foundation, etc.), medicated dental implant, and targeted drug delivery systems.

### PRIORITY CLAIM

This application claims priority to U.S. Provisional Application Ser. No. 61/752,708 entitled “APPLICATIONS OF GLASS MICROPARTICLES AND NANOPARTICLES MANUFACTURED FROM RECYCLED GLASSES ” filed Jan. 15, 2013, which is incorporated herein by reference in its entirety.

### BACKGROUND OF THE INVENTION

1. Field of the Invention

The invention generally relates to applications that use glass microparticles and/or nanoparticles made from recycled glasses.

2. Description of the Relevant Art

Silica microparticles and silica nanoparticles are used in many applications. However, manufacturing silica microparticles and/or silica nanoparticles may be difficult and is expensive. A pound of silica microparticles or silica nanoparticles can cost in a range of $100 to $500 per gram, depending on the size and purity. The high price of silica microparticles and silica nanoparticles makes the use of such particles impractical for many industrial and environmental applications.

### SUMMARY OF THE INVENTION

Glass microparticles and glass nanoparticles can be manufactured economically from recycled glass. There are a myriad of applications of glass microparticles and glass nanoparticles. Applications of glass nanoparticles and glass microparticles include, but are not limited to, reflective paints, abrasive papers/wheels, flame retardant paints, thermal insulation for concretes, self-cleaning stucco, absorbent of oils and gasoline, cosmetics (lipstick, foundation, etc.), medicated dental implant, targeted drug delivery systems, grease trap sensors, 3D glass printing, etc.

In one embodiment, a method of removing environmental hydrocarbon contamination comprises: applying glass microparticles and/or glass nanoparticles to hydrocarbons in a contaminated area; and removing the glass microparticles and/or glass nanoparticles from the contaminated area. The glass microparticles and/or glass nanoparticles may be produced from recycled glass. The method may be used for removal of oil, diesel, and/or gasoline. In some embodiments, the contaminated area comprises a roadway, driveway, or parking area. In other embodiments, the contaminated area comprises a body of water.

In one embodiment, a flame retardant paint comprises: pigments dispersed and/or dissolved in a liquid; and glass microparticles and/or glass nanoparticles. In some embodiments, the pigments are dispersed in an oil-based paint.

In one embodiment, a building material is composed of an aggregate composite material with glass microparticles and/or glass nanoparticles dispersed in the aggregate. As used herein an aggregate composite material is a material that includes an aggregate. Aggregates are coarse particulate materials such as sand, gravel, crushed stone, slag, recycled concrete and geosynthetic aggregates. Examples of aggregate composite materials include concrete, cement, stucco, brick, plaster, and mortar.

In one embodiment, a grease trap sensor includes a glass nanoparticle housing that includes a plurality of glass nanoparticles. The sensor may be placed in a grease trap and provide a signal when the grease trap needs to be cleared of the waste grease. In an embodiment, the glass nanoparticles of the grease sensor absorb fat, oil and grease in the wastewater stream as the wastewater stream is processed through the grease trap. When a predetermined amount of grease is absorbed by the nanoparticles, the increased weight of the nanoparticles causes a signal to be produced which indicates that the grease trap needs to be emptied of the waste hydrocarbons.

In another embodiment, glass nanoparticles may be used to produce 3D glass objects using 3D printing technologies. Glass nanoparticles may be applied in layers and melted/fused together to form 3D glass objects. It was found that relatively low power lasers can be used to form 3D glass objects when using glass nanoparticles.

### BRIEF DESCRIPTION OF THE DRAWINGS

Advantages of the present invention will become apparent to those skilled in the art with the benefit of the following detailed description of embodiments and upon reference to the accompanying drawings in which:

FIG. 1 depicts a projection view of a hydrocarbon sensor; and

FIG. 2 depicts a cross-sectional diagram of a grease trap that includes a hydrocarbon sensor.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

It is to be understood that the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

Broken glasses are a critical solid waste for every municipality. Most municipal waste facilities convert waste glass to pulverized glasses to reduce volume and minimize physical harm from their sharp edges. Low end uses of these pulverized glasses include use as fillers in concrete, foundations in roads, filtration layers etc.

Glass microparticles and/or glass nanoparticles have particle diameters that are less than 10 microns. The term “microparticles”, as used herein, refers to particles that have an average particle size of between 10 microns to about 1 micron. The term “nanoparticles”, as used herein, refers to silica particles that have an average particle size of less than about 1 micron. In some embodiments, microparticles have an average diameter of less than 5 microns, of less than 3 microns, or less than 2 microns. In some embodiments, nanoparticles have an average diameter of less than 500 nm, of less than 250 nm, or less than 100 nm. The term “glass” refers to silica (or silicon dioxide) particles that are manufactured from silica glass. As used herein the term “glass particles” refers to glass nanoparticles, glass microparticles, or mixtures of glass nanoparticles and glass microparticles.

In some embodiments, silica or glass microparticles and/or nanoparticles are commercially available from a number of sources including but not limited to nanoComposix, Inc., San Diego, Calif. Alternatively, glass microparticles and glass nanoparticles may be produced from glass (e.g., waste glass) by various milling processes.

Having an inexpensive readily available source of glass microparticles and glass nanoparticles is helpful in expanding the uses of these particles to various industrial and environmental applications. In one embodiment, glass microparticles and/or glass nanoparticles can be used to remove hydrocarbons from the environment. One useful property of glass microparticles and glass nanoparticles is that these particles are lipophilic and hydrophobic, thus making them ideal for hydrocarbon applications. In an embodiment, glass microparticles and/or glass nanoparticles may be used to absorb hydrocarbons such as vegetable oil, motor oil, diesel, or gasoline. Once the particles are removed from the site, the particles can be recovered and be reused in the same or other applications. One non-limiting example of recovering the particles is to heat the particle-hydrocarbon mixture.

When oil is released into the environment (e.g., from cars onto roadways) it is desirable to remove the oil from the environment. Oil spilled on roadways makes the road extremely slippery and it must be cleaned before other cars can safely use the affected road. In one application, glass microparticles and/or glass nanoparticles are spread over the oil contaminated roadway. The glass microparticles and/or glass nanoparticles absorb and/or adsorb the oil from the road surface, making the roadway passable. The glass microparticles and/or glass nanoparticles, after absorption/adsorption of the oil, can be easily removed by sweeping or vacuuming the particles from the roadway. The removal of oil by glass microparticles and/or glass nanoparticles may also be expanded to driveways, runways and any other surface that oil has been spilled onto. These glass particles can be recovered for further use by heating them to burn off the absorbed oil as a non-limiting example of material separation.

Glass microparticles and/or glass nanoparticles may also be used to clean gasoline or diesel spills. Glass microparticles and/or glass nanoparticles absorb and/or adsorb gasoline or diesel. In some embodiments, gasoline can absorb more than four times its own weight of glass nanoparticles and become non-volatile. Thus, glass microparticles and glass nanoparticles not only help remove the gasoline from the environment, but also render the gasoline safer to transport. Additionally, if the gasoline happens to be floating on water, glass microparticles and glass nanoparticles, being simultaneously hydrophobic and lipophilic, absorb gasoline and float on water initially. The gasoline-glass particles can be easily skimmed from the water. In other applications, adding additional particles (either glass microparticles or glass nanoparticles) cause the gasoline—glass particles to sink in water. Gasoline has a lower density than water, while glass particles have a higher density than water. Depending on the amount of glass particles mixed with the gasoline, the density of the resulting mixture changes and accordingly the mixture will either float or sink. This represents a novel way to deal with hydrocarbon environmental disasters. Another unique property of these gasoline soaked glass particles is their ability to be re-used again by burning the gasoline in a safe, controlled manner. This opens up the opportunity to not only recover the gasoline from a spill and re-use the glass particles; but also to use the heat content of the gasoline albeit as a solid fuel. These general observations are true for diesel also.

In another embodiment, glass microparticles and/or glass nanoparticles may be used for hazardous spills of other hydrocarbons such as ethanol, methanol, and acetone, as non-limiting examples. Once these spills are contained the combined glass particle-hydrocarbons can be swept to clean-up the area.

In another embodiment, glass microparticles and glass nanoparticles may be used for hazardous spills of automobile fluids such as brake fluids and transmissions fluids. Combinations of these fluids along with gasoline or diesel and/or oil make glass microparticles and glass nanoparticles an attractive alternative to other commercially available materials used to clean automobile accident sites.

Glass microparticles and/or glass nanoparticles may be used to transfer hydrocarbons. It has been found that hydrocarbons, when absorbed/adsorbed onto glass microparticles or glass nanoparticles are less combustible. This feature of making a safely transportable fuel by combining glass microparticles and/or glass nanoparticles with an easily combustible fuel like gasoline, diesel, or kerosene (as non-limiting examples) opens-up opportunities for both pleasure (say picnic) and practical (remote villages) applications of transporting fuel to target areas. Once the fuel is used-up, the glass particles can be soaked in the fuel again and re-used as safely transportable fuel.

In another embodiment, glass microparticles and/or glass nanoparticles may be used in paints to improve the flame retardancy of the paint. Glass microparticles and/or glass nanoparticles are mixed with paint and the resulting paint-glass particle mixture exhibits improved flame retardancy. In one example, glass microparticles and/or glass nanoparticles were added to paint and the paint applied to a sheet rock surface. As a control, the same paint, without the glass particles, was applied to a sheet rock surface. Both surfaces were burned and it was found that the sheet rock that is coated with paint that includes glass microparticles and/or glass nanoparticles took about 50% longer to burn than the control sheet rock. It was also found that the burn time depends on a number of factors such as glass particle size, amount of glass particles, mixing method, etc. The texture of the wall painted with the glass particle paint did not feel any different than paints that did not include glass particles.

In another embodiment, glass microparticles and glass nanoparticles exhibit thermal insulation properties. Glass microparticles and/or glass nanoparticles can be incorporated into building materials, for example, to improve the thermal insulation properties of such materials. For example, glass microparticles and/or glass nanoparticles may be incorporated into concrete to improve the thermal properties of the concrete. In one example, glass microparticles and/or glass nanoparticles were incorporated into a concrete slab. When heat was applied to the glass particle containing concrete slab, the heat was transferred at a rate significantly slower than the rate at which the heat is transferred in an unmodified concrete slab. In one embodiment, heat transfer was three times slower in glass particle containing concrete slab compared to an unmodified concrete slab. Thermal insulation effect depends on a number of factors such as glass particle size, amount of glass particles, mixing method, homogeneity, etc. Glass nanoparticles may also be included in drywall, sheetrock, or equivalent materials.

The hydrophobic nature of glass nanoparticles can be used to create a so-called “lotus effect”. If mixed with appropriate amount of stucco (for example), the resulting mixture will repel water to mimic self-cleaning behavior of lotus petals. This will allow the stucco to keep its natural clean texture for dramatically longer period. Glass nanoparticles also act as acoustic attenuators when incorporated into building materials.

Grease traps are used by various public and commercial food preparation sites to minimize the amount of fat, oil and grease (“FOG”) that is introduced into a municipal or private sewage system. The grease trap separates a substantial portion of FOG from the wastewater produced at the site to provide partially separated wastewater stream to a water treatment system. In an embodiment, a hydrocarbon sensor disposed in a grease trap may be used to alert the food providers to call for services to remove the separated FOG as needed. This will help the food providers to lower their operational costs by minimizing calls to “when needed” rather than to an arbitrarily fixed time by the waste management companies (e.g., every 30 days, every 60 days, etc.). Apart from potential higher operational cost, use of a fixed time schedule also has a higher risks of unexpected overflow due to sudden increase in food production. The described hydrocarbon sensor may help to ensure service calls are made only when needed (whether sooner or later than a fixed time schedule).

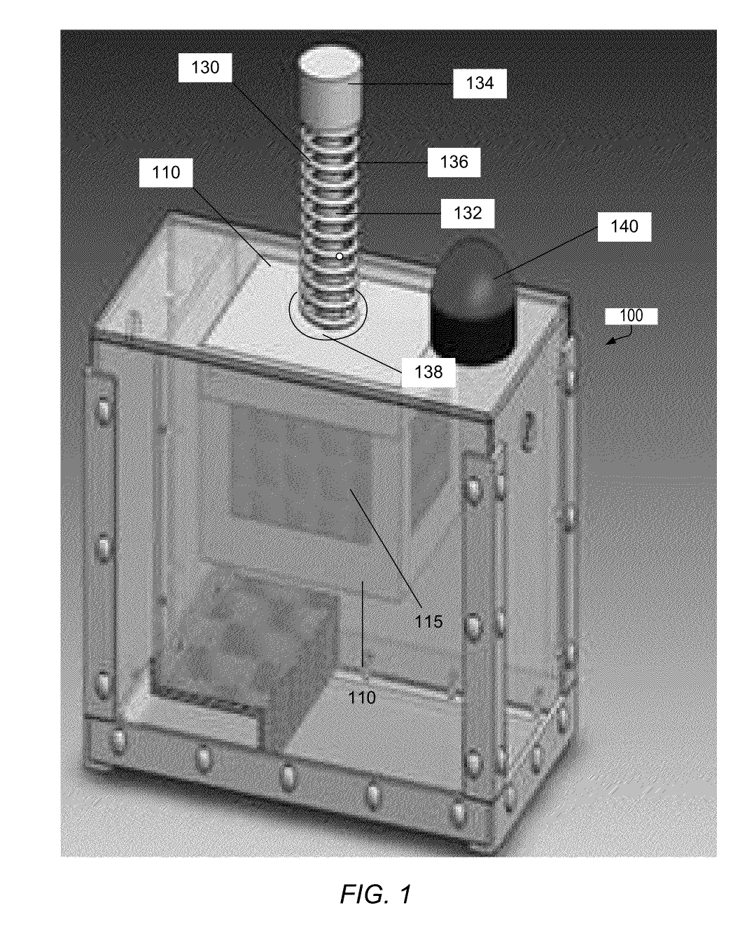

FIG. 1 depicts an embodiment of a hydrocarbon sensor that is based on the hydrophobic and lipophilic characteristics of glass nanoparticles. The hydrocarbon sensor generally includes a housing that includes glass nanoparticles. As the glass nanoparticles absorb oil, the nanoparticles become heavier, causing the weight of the housing to increase. When the housing exceeds a predetermined weight, a signaling system provides a visible and/or auditory alert. This alert will indicate that the grease trap is in need of servicing. In an embodiment, the signaling system can provide a wireless signal directly to waste liquid management centers. Such hydrocarbon sensors can be retrofitted with existing grease traps so that the operators need not buy a whole new system.

Turning to FIG. 1, a hydrocarbon sensor 100 includes a housing 110 which includes a plurality of glass nanoparticles. Housing 110 comprises one or more walls 115 having passages that allow fluids to pass into and through the housing. In an embodiment, one or more walls of housing 110 are formed from a mesh material that is capable of allowing fluid (e.g., wastewater) pass into and through the housing while substantially retaining the glass nanoparticles. Housing 110 is coupled to support 120.

Hydrocarbon sensor 100 includes a weighing system 130. Weighing system 130 is coupled to housing 110 and support 120. During use, weighing system 130 provides a signal when the weight of housing 100 changes. In a specific embodiment, the weighing system provides a signal when the weight of the housing changes by at least a predetermined amount. A specific example of weighing system 130 is depicted in FIG. 1, although other systems capable of determining a change in weight of housing 100 may be used. In the embodiment depicted in FIG. 1, weighing system 130 includes an elongated rod 132 comprising a cap 134. Elongated rod 132 is coupled to housing 110 (e.g., the end of elongated rod 132 is coupled to the upper surface of housing 110). A spring 136 is disposed between cap 134 and support 120. Spring 136 provides resistance to the weight of the housing and glass nanoparticles contained therein. The resistance of the spring 136, therefore, holds housing 110 in a relatively fixed position until the weight of the housing exceeds the resistive force of the spring. At a predetermined change in weight of housing 110 (determined, in part, by the physical properties of spring 136 positioned between cap 134 and support 120) the housing will begin to be pulled (by gravity) away from support 120. When housing 110 moves a predetermined distance (e.g., when cap 134 contacts support 120) a signal may be produced and sent to a signaling system. In an embodiment, contact of cap 134 with a sensor 138 disposed on substrate 120 may create an electrical connection, producing an electrical signal that indicates that the housing has exceeded a predetermined weight.

Signaling system 140 is coupled to weighing system 130 and receives signals from the weighing system. Upon receipt of a signal from weighing system 130, signaling system 140 produces a visual and/or auditory alert. A visual alert may be a light that flashes or is a specific color to indicate that the grease trap needs cleaning An auditory alert may be a beeping noise, a constant alarm, or a voice message that indicates that the grease trap needs cleaning. In some embodiments, signaling system 140 may transmit a wireless signal that is received by the owner of the grease trap or by a waste management system in charge of maintenance of the grease trap. The wireless signal may provide an indication (e.g., a text message or email) that the grease trap requires maintenance.

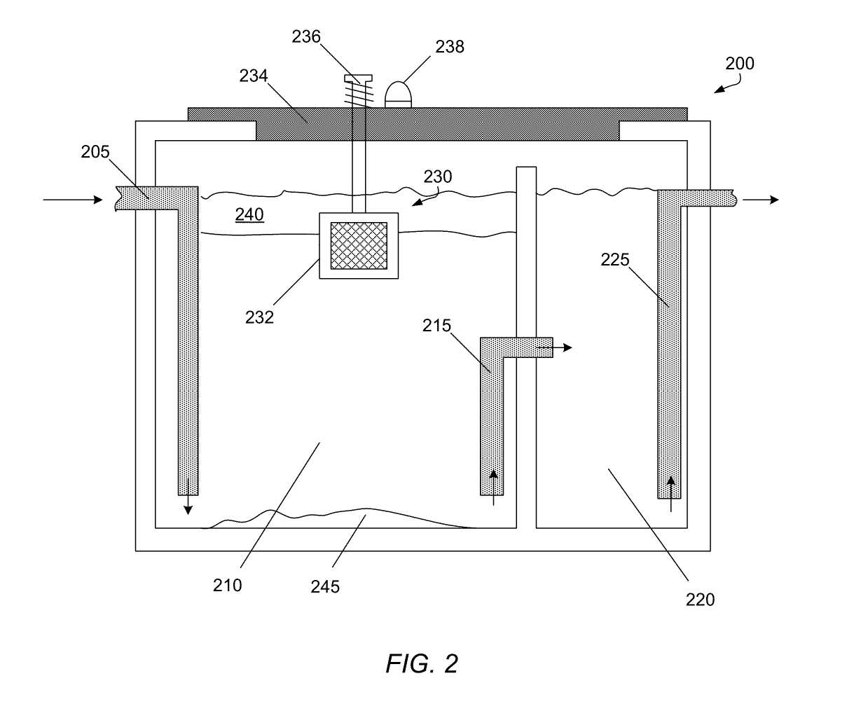

In an embodiment, a hydrocarbon sensor 230 may be incorporated into a grease trap 200 as depicted in FIG. 2. A typical grease trap includes a separation chamber 210 and a separated wastewater chamber 220. During use, wastewater containing FOG and other food products enters grease trap 200 through wastewater inlet 205. The wastewater enters separation chamber 210 where the FOG 240 rises to the top of the water contained in the separation chamber. Undissolved food particles and other solids 245 sink to the bottom of separation chamber 210, leaving partially cleaned wastewater in the middle of the separation chamber. A crossover conduit 215 transfers separated wastewater from separation chamber 210 to separated wastewater chamber 220. Crossover conduit 215 is positioned near the bottom of the separation chamber to inhibit grease from being transferred to separated wastewater chamber 220. Separated wastewater leaves separated wastewater chamber 220 via wastewater outlet 225 and is passed to a municipal or private wastewater treatment facility.

Because there is no inherent mechanism to remove FOG from the grease trap, the trap requires servicing to manually remove the collected FOG. In an embodiment, a hydrocarbon sensor 230 may be disposed in the grease trap to indicate when the level of FOG has reached a predetermined limit. Hydrocarbon sensor 230 includes a housing 232 that includes a plurality of glass nanoparticles. Housing 232 includes one or more walls having passages that allow fluids to pass through the housing. Housing 232 is coupled to support 234. In some embodiments, support 234 forms at least a portion of a lid covering separation chamber 210. Hydrocarbon sensor also includes weighing system 236 and signaling system 238 as described above.

Hydrocarbon sensor 230 is positioned within the separation chamber at a position that will produce an alert when the level of hydrocarbon waste (e.g., FOG) captured by separation chamber is at least about 60%, at least about 70%, at least about 80%, or at least about 90% of the capacity of the grease trap. During use, the glass nanoparticles will absorb the FOG from the grease trap, causing the housing to sink in the water to trip the alarm at the predetermined trip points. The oil-soaked glass nanoparticles can be burnt to recover the biofuel and re-used in the grease trap.

Laser fusion and/or melting has been successfully used in 3D printing. Many polymers (e.g., polystyrene, polyamides, etc. both unfilled and filled) and metals (stainless steel, nickel alloys, titanium, aluminum, etc.) have been successfully used to make 3D parts using various laser sources. Most common laser sources include CO₂ (low 30 W) or Ytterbium (200 W). While low energy laser is typically adequate for making polymer parts, high energy lasers are required for metals.

In an embodiment, glass nanoparticles may be used in a 3D printing process to form glass particles. The 3D process includes forming a layer of glass nanoparticles on a surface. A laser is directed at the layer of glass nanoparticles in a predetermined pattern. The energy of the laser is sufficient to melt and fuse together the glass nanoparticles within the predetermined pattern. By using glass nanoparticles it was found that 3D objects could be formed using a low powered CO₂ laser (120 W). The use of a relatively low energy laser allows glass parts to be manufactured more economically.

In some embodiments, the color of the glass formed by fusion of the glass nanoparticles may be altered by adjusting the intensity of light from the laser and/or the time that the glass nanoparticles are subjected to light from the laser.

In an embodiment, a method of forming a three-dimensional glass object includes: obtaining a glass forming composition comprising glass nanoparticles and a hydrophilic liquid; shaping the glass forming composition into a shape corresponding to the three-dimensional glass object; and sintering the glass forming composition to produce the three-dimensional glass object, wherein the sintering is performed at a temperature sufficient to at least partially remove the hydrophilic liquid. The hydrophilic liquid, in some embodiments, is a hydrocarbon solvent (e.g., hexane, petroleum ether, cyclohexane, toluene, xylene, etc.). In other embodiments, the hydrophilic liquid comprises an oil (e.g., vegetable oil). The glass forming composition may also include a binder. A binder may be used to help hold the object together during sintering. The glass forming composition may also include other additives such as dyes and other additives that affect the finish of the produced glass object.

The glass forming composition may be shaped into the desired form and sintered. In one embodiment, the glass forming composition may be placed into a mold complementary to the desired shape. The shaped glass forming composition may be sintered at a temperature sufficient to at least partially remove the hydrophilic liquid, and other undesirable materials (e.g., binders) present in the glass forming composition.

Other applications of glass particles include uses in reflective paints, abrasive papers/wheels, cosmetics (lipstick, foundation, etc.), dental implants, and targeted drug delivery systems. In drug delivery and cosmetic systems glass particles can be heated to 1,000° F. or above to make them aseptic for many medical/pharmaceutical applications.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A method of removing environmental hydrocarbon contamination comprising:
applying glass microparticles and/or glass nanoparticles to hydrocarbons in a contaminated area;
removing the glass microparticles and/or glass nanoparticles soaked with hydrocarbons from the contaminated area.

2. The method of claim 1, wherein the glass microparticles and glass nanoparticles are applied to the hydrocarbons in the contaminated area.

3. The method of claim 1, wherein glass microparticles and/or glass nanoparticles are produced from recycled glass.

4. The method of claim 1, wherein the hydrocarbons comprises oil.

5. The method of claim 1, wherein the hydrocarbons comprise gasoline or diesel.

6. The method of claim 1, wherein the hydrocarbons comprise motor oil.

7. The method of claim 1, wherein the hydrocarbons comprise brake and transmission fluids

8. The method of claim 1, wherein hydrocarbons comprise ethanol or methanol.

9. The method of claim 1, wherein the hydrocarbon comprise acetone.

10. The method of claim 1, wherein the contaminated area comprises a roadway, driveway, raceway, or parking area.

11. The method of claim 1, wherein the contaminated area comprises a body of water.

12. The method of claim 1, further comprising using the resulting combination of hydrocarbon and glass particles as a fuel for another application.

13. The method of claim 1, wherein the hydrocarbons comprises oil, gasoline, diesel, ethanol, methanol, brake fluids, transmission fluid, acetone, or mixtures thereof.

14-43. (canceled)

44. The method of claim 1, further comprising regenerating the glass microparticles and/or glass nanoparticles by removing the hydrocarbons.
